(19) United States
(12) Patent Application Publication
(10) Pub. No.: US 2010/0303223 A1
(43) Pub. Date: Dec. 2, 2010

(54) METHOD AND APPARATUS FOR PROVIDING NETWORK-BASED SUPPORT FOR ANNOUNCEMENTS FOR CALLS AWAITING ANSWER WHEN ALL LINES IN THE MULTI-LINE HUNT GROUP ARE BUSY

(75) Inventors: William J. Bushnell, St. Charles, IL (US); Nicholas M. DeVito, Naperville, IL (US)

Correspondence Address: FAY SHARPE/LUCENT, 1228 Euclid Avenue, 5th Floor, The Halle Building, Cleveland, OH, 44115-1843, US

(73) Assignee: Alcatel-Lucent USA Inc.

(21) Appl. No.: 12/473,516

(22) Filed: May 28, 2009

(51) Int. Cl. H04M 3/42

(52) U.S. Cl. 379/207.16

(57) ABSTRACT

A method and system are provided to allow ringback tones that provide personalized ringback greetings on calls that have reached a multi-line hunt group in which all lines are busy. The personalized ringback greeting is continued until an agent is available to answer the call. In one form, if more than one call is awaiting answer, the ringback application determines which call has been listening to the ringback announcement longest and forwards that call to the next available agent. All other calls receive the standard ringback tones.

### BACKGROUND OF THE INVENTION

This invention relates to a method and apparatus for providing network-based support for announcements for calls awaiting answer. While the invention is particularly directed to the art of such network-based supported features, and will be thus described with specific reference thereto, it will be appreciated that the invention may have usefulness in other fields and applications.

By way of background, small businesses today purchase multiple telephone lines and key systems so that they can efficiently answer incoming calls from customers. Often, a business purchases more incoming lines than they have employees to answer the calls. If all of the employees are busy and another call arrives, the employee can put one of the existing calls on hold and answer the incoming call. Typically, the employee will answer the call, inform the caller of the name of the business and ask the caller to wait on hold until they can be served. Often, the caller will hear music or advertisements while they are on hold. Eventually, an employee will complete serving an earlier customer and will pick up the call and serve the caller.

MultiLine Hunt Group lines may be equipped with a network based Ringback service. With this arrangement, when a customer calls a business, they will hear a pre-recorded message while awaiting for the call to be answered. This pre-recorded message is played in place of the standard ringing recording that callers hear while awaiting answer. The pre-recorded message can announce the name of the business, special promotions and a request to wait for an agent to answer their call.

With the pre-recorded Ringback service, the employees of the business do not have to answer incoming calls and place them on hold. The employees can complete a current call and then pick up the call that is awaiting answer. When the employee answers a new call, the pre-recorded announcement is terminated.

The above situation works well for calls that are awaiting answer. However, this arrangement requires that the business has sufficient incoming lines to support the calls that are in the talking state and the calls that are awaiting answer. If all of the incoming lines are busy, subsequent incoming calls receive either a busy treatment or they are sent to a voice mail box.

Network-based Automatic Call Distributors may solve some of these issues for large business with large numbers of call center agents. Such systems provide multiple call queues and announcements for waiting calls. The calls are queued in a dedicated network so that the businesses do not have to purchase telephone lines for the queued calls. However, these systems have expensive dedicated equipment for handling calls and generating announcements. In general, these systems are too complex and too expensive to be used by small businesses.

The technique described herein allows the small business to continue to use their existing key system and multiline hunt group arrangement—but allow calls to queue in the network and receive pre-recorded greetings when all of the lines in the multi-line hunt group are busy.

### SUMMARY OF THE INVENTION

A method and apparatus for network-based support for announcements for calls awaiting answer when all of the lines in a multi-line hunt group are busy are provided.

In one aspect of the presently described embodiments, a method comprises receiving a call from a calling party at a network terminating switch having a multi-line hunt group line unit, determining, by a processor, if all lines of the multi-line hunt group line unit are busy, applying call waiting treatment to all lines in the multi-line hunt group that are in a talking state, routing the call to a ringback application server and playing a greeting or ringtone to the calling party.

In another aspect of the presently described embodiments, the method further comprises determining the greeting or ringtone by the processor by accessing a subscriber database.

In another aspect of the presently described embodiments, the routing includes routing information identifying the greeting or ringtone.

In another aspect of the presently described embodiments, the greeting is selected by a subscriber.

In another aspect of the presently described embodiments, the method further comprises detecting completion of another call in the multi-line hunt group, the completion creating an idle line, determining if other calls are waiting, if the other calls are waiting, applying power ringing to the idle line, connecting a waiting call to the idle line upon answering, and, terminating the greeting or ringtone to the waiting call.

In another aspect of the presently described embodiments, the terminating comprises signaling the ringback server by the processor.

In another aspect of the presently described embodiments, the applying power ringing to the idle line is based on a longest waiting call.

In another aspect of the presently described embodiments, a system comprises a terminating switch having a multi-line hunt group line unit and including a processor operative to receive a call from a calling party, determine if all lines of the multi-line hunt group line unit are busy, apply call waiting treatment if all lines are busy and route the call, and, a ringback application server operative to receive the call routed by the terminating switch and play a greeting or ringtone to the calling party.

In another aspect of the presently described embodiments, the system further comprises a subscriber database within the terminating switch for storing information on selected ringtones and greetings for subscribers.

In another aspect of the presently described embodiments, the processor is operative to route the call to the ringback server with information identifying the greeting or ringtone for a subscriber.

In another aspect of the presently described embodiments, the processor is operative to detect completion of another call in the multi-line hunt group, the completion creating an idle line, determine if other calls are waiting, if the other calls are waiting apply power ringing to the idle line, connect a waiting call to the idle line upon answer, and signal the ringback application server to terminate the greeting or ringtone to the waiting call.

In another aspect of the presently described embodiments, the ringback server is operative to terminate the greeting or ringtone upon receipt of the signal from the processor.

In another aspect of the presently described embodiments, the processor is further operative to determine the longest waiting call.

In another aspect of the presently described embodiments, a system comprises means for receiving a call from a calling party at a network terminating switch having a multi-line hunt group line unit, means for determining if all lines of the multi-line hunt group line unit are busy, means for applying call waiting treatment if all lines are busy, means for routing the call to a ringback application server and means for playing a greeting or ringtone to the calling party.

In another aspect of the presently described embodiments, the system further comprises means for determining the greeting or ringtone by accessing a subscriber database.

In another aspect of the presently described embodiments, the means for routing includes means for routing information identifying the greeting or ringtone.

In another aspect of the presently described embodiments, the system further comprises means for detecting completion of another call in the multi-line hunt group, the completion creating an idle line, means for determining if other calls are waiting, means for applying ringing to the idle line, if the other calls are waiting, means for connecting a waiting call to the idle line, and, means for terminating the greeting or ringtone to the waiting call.

In another aspect of the presently described embodiments, the system further comprises means for signaling the means for terminating the greeting or ringtone.

In another aspect of the presently described embodiments, the system further comprises means for determining the longest waiting call.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

Some embodiments of apparatus and/or methods in accordance with embodiments of the present invention are now described, by way of example only, and with reference to the accompanying drawings, in which:

FIG. 1 is a block diagram of an example system into which the presently described embodiments are implemented;

FIG. 2 is a flow chart illustrating at least part of a method according to the presently described embodiments; and,

FIG. 3 is a flow chart illustrating at least part of a method according to the presently described embodiments.

### DETAILED DESCRIPTION

Current technology provides a mechanism to allow network-based announcements for calls awaiting answer. This can be applied to single lines or it can be applied to lines in a multi-line hunt group. However, the current solution only works if the line is idle. A simple cost effective solution for small businesses that provides network-based announcements for calls awaiting answer—when all lines in a multi-line hunt group are busy—is provided by the presently described embodiments. This mechanism allows the business to decrease the number of lines in the multi-line hunt group while still providing the same level of customer service,

Furthermore, the networkbased announcements are, in at least one form, tailored to the business that is being called. For example, the following types of messages may be desired for a small business:

“Thanks for calling Bill Plumber's. It has been our pleasure to serve you in the past. We will be with you in one moment.”

“Thanks for calling Nick's Bookstore. We appreciate your recent order. We will be with you in one moment. You can check the status of your order at NicksBookstore.com”

In this regard, personalized pre-recorded ringback greetings technology has emerged that provides greetings to all calls awaiting answer. Instead of hearing a standard ringing tone, the calling party hears music or an announcement that is selected by the called party. The ringback tone or greetings are played on all calls awaiting answer. Ringback tones and greetings are generated by network-based equipment and are designed to support large numbers of individual subscribers. The existing ringback equipment allows the called party to select the ringback tone to be applied to all calls, or the called party can designate that different ringback tones or greetings be played—depending on the calling party ID.

According to the presently described embodiments, by using this equipment for ringback service for both individual subscribers and small businesses, the service providers can achieve network efficiency and cost savings.

The presently described embodiments encompass modifying the logic for network-based multi-line hunt group services and the logic for applying ringback tones—so that it essentially provides personalized ringback greetings on calls that have reached a multi-line hunt group in which all lines are busy. When implemented, the personalized ringback greeting is continued until an agent is available to answer the call. In one example form, if more than one call is awaiting answer, the ringback application determines which call has been listening to the ringback announcement the longest and forwards that call to the next available agent. All other calls receive the standard ringback tones and greetings.

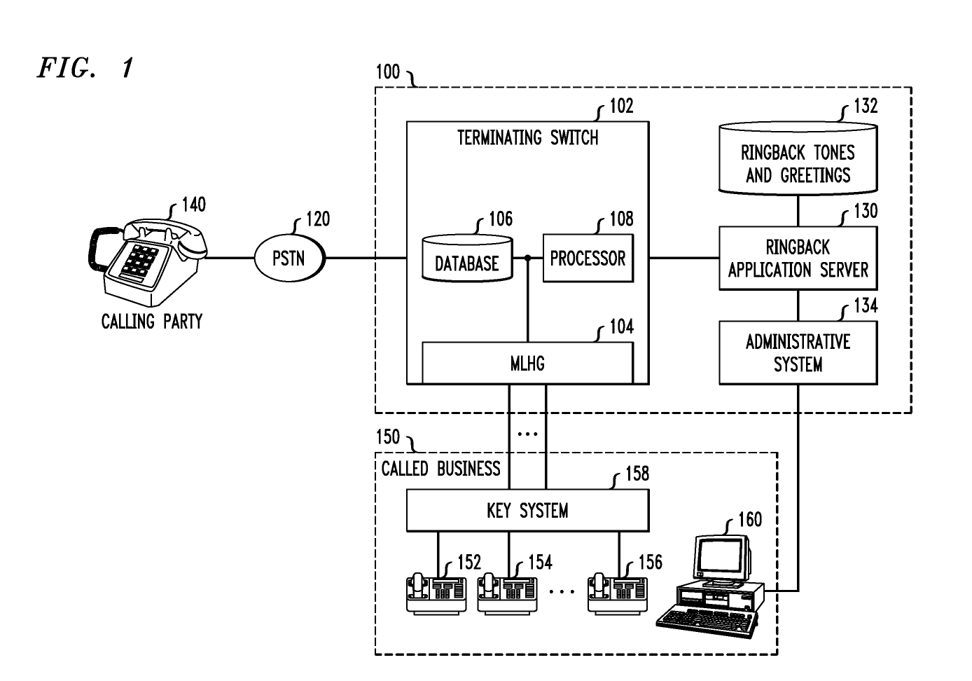

Referring now to the drawings wherein the showings are for purposes of illustrating the exemplary embodiments only and not for purposes of limiting the claimed subject matter, FIG. 1 provides a view of a system into which the presently described embodiments are incorporated. As shown generally in FIG. 1, the presently described embodiments can be implemented by modifying the logic relating to a multi-line hunt group in a terminating switch and by uniquely accessing and using an application server that provides the ringback tones and greetings.

As shown, a system 100 includes a terminating switch 102 that can take a variety of forms. In at least one form, the terminating switch 102 includes a line unit that provides a multi-line hunt group (MLHG) line unit function 104, a database such as a subscriber database 106 and a processor module 108. It is to be appreciated that other elements may be included in the terminating switch 102; however, such elements are not described here for ease of reference. It will be appreciated that terminating switching 102, unless otherwise described and/or apparent from the implementation of the presently described embodiments, is configured and operates in manners that are well known to those in the field.

As shown in the exemplary configuration of FIG. 1, the terminating switch 102 is in communication with the public-switched telephone network (PSTN) 120, as well as a ringback application server 130. The public-switched telephone network (PSTN) 120 may take a variety of well known configurations. The ringback application server 130 is, in at least one form, connected to a database 132 which, in at least one form, stores ringback tones and greetings, as described above. The ringback application server 130 is also in communication with an administrative system 134.

The processor 108 may take a variety of forms and configurations; however, in at least one form, the processor 108 is operative to receive a call from a calling party, determine if all lines of the multi-line hunt group line unit are busy and apply call waiting treatment to all lines in the multi-line hunt group. The processor may also be operative to route the call to the ringback application server with information identifying the greeting or ringtone for a subscriber. In addition, the processor is operative to detect completion of another call in the multi-line hunt group and determine if other calls are waiting. In one form, if other calls are waiting, the processor determines which other call has waited longest, and transfers the call that has waited longest to the available line in the multi-line hunt group. Otherwise, if other calls are waiting, the terminating switch applies power ringing to the available line created by the completion of a call to alert the key system of the awaiting call. Once the call is answered by the one of the phones in the key system, the ringback greeting is suspended.

Like the processor 108, the ringback application server 130 may take a variety of forms and configurations, however, in at least one form, the ringback application server is operative to receive the call routed by the terminating switch and play a greeting or ringtone to the calling party.

The network-supported system 100 is also connected to various entities within the network such as a calling party 140 and/or a called business entity 150 which has a multi-line key system 158. It should be appreciated that the calling party 140 may use a variety of technologies, including wire-line communication technology or wireless technology, to communicate with the public-switched telephone network (PSTN) 120. So, the calling party 140 may use a Plain Old Telephone System (POTS) device, a mobile device, or other suitable devices.

Likewise, the called business entity 150 may utilize a variety of different devices such as handsets 152, 154 and 156. It should be appreciated that the handsets 152, 154 and 156 are in communication via the multi-line key system 158, in at least one form, with the multi-line hunt group (MLHG) line unit 104 and exchange traditional analog line signaling and analog voice transport or digital line signaling and digital voice transport or IP packet signaling (e.g. SIP signaling) and packet voice transport (e.g. RTSP). The called business entity 150 may also include a personal computer or other suitable interface 160 connected, in any suitable manner, to the administrative system 134.

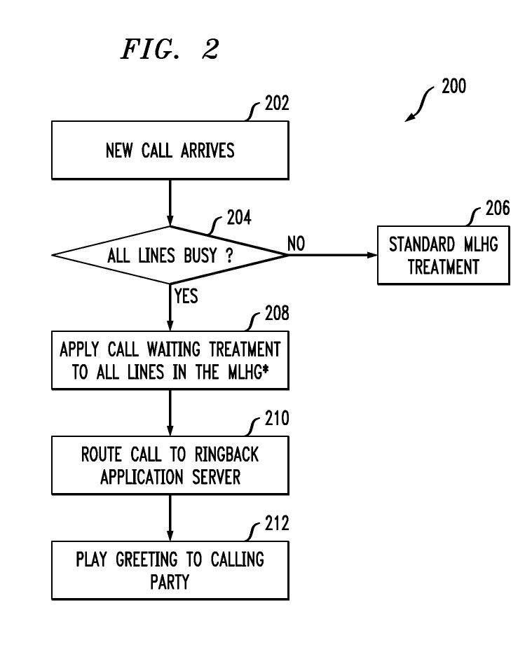

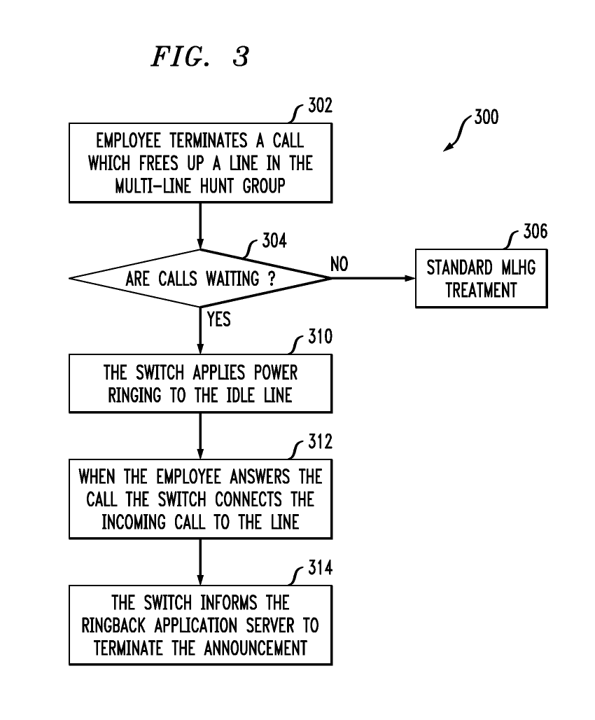

Example forms of the application logic and/or methods according to the presently described embodiments are described in FIGS. 2 and 3. The logic can be implemented in a variety of environments including on existing circuit switched technology. For circuit switched technology, for example, the presently described embodiments are realized by either implementing the logic and/or methods directly in a switch (such as terminating switch 102 as described in FIG. 1) by using, for example, a suitable processor (such as processor 108) and a database (such as subscriber database 106) or by implementing the logic in Intelligent Network SCPs in an appropriate manner. The logic and/or methods can also be implemented in VoIP packet switched networks using SoftSwitch technology or an IMS service architecture. As such, it should be appreciated that a variety of hardware configurations and/or software techniques can be used to implement the logic and/or methods of the presently described embodiments.

Also, it should be appreciated by those skilled in the art that any block diagrams herein represent conceptual views of illustrative circuitry embodying the principles of the invention. Similarly, it will be appreciated that any flow charts, flow diagrams, and/or the like represent various processes which may be substantially represented in computer readable medium and so executed by a computer or processor, whether or not such computer or processor is explicitly shown.

With reference now to FIG. 2, a method 200 is illustrated. The method 200 is initiated upon the arrival of a new call (at 202), for example, at the terminating switch 102. A determination is then made by, for example, the processor 108 as to whether all lines serviced by the multi-line hunt group (MLHG) line unit 104 are busy, e.g. in a talking state (at 204). If not, the standard multi-line hunt group (MLHG) treatment is provided by the line unit 104 (at 206). If all lines are busy, call waiting treatment is applied to all lines in the multi-line hunt group by the processor 108 (at 208). Also, the processor 108 retrieves subscriber information from the subscriber database 106, the subscriber information including data on selected ringback tones and greetings for the subscriber. The call is routed to the ringback application server 130 by the processor 108 (at 210), along with the subscriber information. This can be accomplished using any known messaging technique. The ringback application server 130 then accesses the database 132 to select specific ringback tones and greetings based on the information retrieved from the subscribe database 106. Next, the greeting or ringback tone is played back to the calling party (at 212). This continues until such time as the calling party terminates the call (i.e. hangs up) or a line within the multi-line hint group (MLHG) becomes available.

With reference now to FIG. 3, a method 300 is illustrated. The method 300 is initiated upon the termination or completion of a call by an employee (at 302), for example, an employee fielding calls at the called business entity 150 using any one of the example handsets 152, 154 or 156. This event may be detected by, for example, the processor 106. Of course, completion of a call creates an idle line. A determination is then made by the processor 108 as to whether other calls are waiting (at 304). If not, standard multi-line hunt group (MLHG) treatment is provided (at 306). If calls are waiting, the terminating switch 102, applies power ringing to the idle line in the multi-line hunt group (at 310). When the employee answers the ringing line, the terminating switch 102 connects the call awaiting answer to the line in the multi-line hunt group that was just answered (at 312). The switch signals the ringback application server to teriminate the ringback tone and/or greeting (at 314). Also, as an option and as noted above, the selection of calls to connect to the idle line may be based on a determination by the processor of the longest waiting call. This can be accomplished in a variety of suitable manners.

It should also be appreciated that the presently described embodiments will allow for a subscribing business to tailor the application of the presently described embodiments to suit its business needs. So, in at least one form, a business may subscribe to the service of the presently described embodiments in an on-line or other suitable manner through, for example, the interface 160 and the administrative system 134. When doing so, the business will provide the telephone number for the business, the number of lines in the multi-line hunt group (MLHG) and also specify a greeting to be played for customers awaiting an answer to their call. This information will, in one form, be stored in the subscriber database 106 and in the Ringback Tone and Greeting database (132). In this way, announcements may be specified in a variety of manners, including on a “per calling group” basis, for example. The groups may be updated as new customers are added or existing customers purchase items, for example. The greetings may also be updated by the subscribing business as a function of their needs. For example, a subscribing business may change the greeting to allow for different weekly advertisements to be announced.

Various modifications to the presently described embodiments are possible:
1) The system can be easily extended so that subscribing business can record their own greetings and load the greetings into the ringback tone server.
2) The subscribing business can record multiple announcements and designate via Caller ID lists, which calls should receive which announcement.

In addition to playing the announcement only on calls awaiting answer when all lines are busy, the system could also play a short welcome greeting on all calls. These announcements provide feedback to the caller that they have reached the appropriate number. To insure that the calling party hears the entire greeting, the calls will not be sent to the lines in the multi-line hunt group until the announcement has terminated.

As noted above, a person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers or processors programmed to perform said steps of the above-describe methods.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for providing network-based announcements to calls awaiting answer within a multi-line hunt group, the method comprising:
receiving a call from a calling party at a network terminating switch having a multi-line hunt group line unit;
determining, by a processor, if all lines of the multi-line hunt group line unit are busy;
applying call waiting treatment to all lines in the multi-line hunt group that are in a talking state;
routing the call to a ringback application server; and,
playing a greeting or ringtone to the calling party.

2. The method as set forth in claim 1 further comprising determining the greeting or ringtone by the processor by accessing a subscriber database.

3. The method as set forth in claim 2 wherein the routing includes routing information identifying the greeting or ringtone.

4. The method as set forth in claim 1 wherein the greeting is selected by a subscriber.

5. The method as set forth in claim 1 further comprising:
detecting completion of another call in the multi-line hunt group, the completion creating an idle line;
determining if other calls are waiting;
if the other calls are waiting, applying power ringing to the idle line;
connecting a waiting call to the idle line upon answering; and,
terminating the greeting or ringtone to the waiting call.

6. The method as set forth in claim 5 wherein the terminating comprises signaling the ringback server by the processor.

7. The method as set forth in claim 5 wherein the applying power ringing to the idle line is based on a longest waiting call.

8. A system for providing network-based announcements to calls awaiting answer within a multi-line hunt group, the system comprising:
a terminating switch having a multi-line hunt group line unit and including a processor operative to receive a call from a calling party, determine if all lines of the multi-line hunt group line unit are busy, apply call waiting treatment if all lines are busy and route the call; and,
a ringback application server operative to receive the call routed by the terminating switch and play a greeting or ringtone to the calling party.

9. The system as set forth in claim 8 further comprising a subscriber database within the terminating switch for storing information on selected ringtones and greetings for subscribers.

10. The system as set forth in claim 9 wherein the processor is operative to route the call to the ringback server with information identifying the greeting or ringtone for a subscriber.

11. The system as set forth in claim 8 wherein the processor is operative to detect completion of another call in the multi-line hunt group, the completion creating an idle line, determine if other calls are waiting, if the other calls are waiting apply power ringing to the idle line, connect a waiting call to the idle line upon answer, and signal the ringback application server to terminate the greeting or ringtone to the waiting call.

12. The system as set forth in claim 11 wherein the ringback server is operative to terminate the greeting or ringtone upon receipt of the signal from the processor.

13. The system as set forth in claim 11 wherein the processor is further operative to determine the longest waiting call.

14. A system for providing network-based announcements to calls awaiting answer within a multi-line hunt group, the system comprising:
means for receiving a call from a calling party at a network terminating switch having a multi-line hunt group line unit;
means for determining if all lines of the multi-line hunt group line unit are busy;
means for applying call waiting treatment if all lines are busy;
means for routing the call to a ringback application server; and,
means for playing a greeting or ringtone to the calling party.

15. The system as set forth in claim 14 further comprising means for determining the greeting or ringtone by accessing a subscriber database.

16. The system as set forth in claim 15 wherein the means for routing includes means for routing information identifying the greeting or ringtone.

17. The system as set forth in claim 14 further comprising:
means for detecting completion of another call in the multi-line hunt group, the completion creating an idle line;
means for determining if other calls are waiting;
means for applying ringing to the idle line, if the other calls are waiting; means for connecting a waiting call to the idle line; and,
means for terminating the greeting or ringtone to the waiting call.

18. The system as set forth in claim 17 further comprising means for signaling the means for terminating the greeting or ringtone.

19. The system as set forth in claim 17 further comprising means for determining the longest waiting call.
